(19) United States
(12) Patent Application Publication
(10) Pub. No.: US 2008/0026693 A1
(43) Pub. Date: Jan. 31, 2008

(54) Multihop Radio Network System

(75) Inventors: Hiraku Okada, Aichi (JP); Takaya Yamazato, Aichi (JP); Masaaki Katayama, Aichi (JP); Naohisa Koie, Tokyo (JP); Nobuyuki Nakagawa, Aichi (JP)

Correspondence Address: RADER FISHMAN & GRAUER PLLC, LION BUILDING, 1233 20TH STREET N.W., SUITE 501, WASHINGTON, DC, 20036, US

(73) Assignee: Japan Science and Technology Agency, Kawaguchi-shi, Saitama (JP)

(21) Appl. No.: 10/589,978

(22) PCT Filed: Sep. 9, 2004
(86) PCT No.: PCT/JP04/13112

§ 371 Date: Jun. 14, 2007

(30) Foreign Application Priority Data
Feb. 20, 2004 (JP) 2004-044436

(51) Int. Cl. H04B 7/15; H04B 7/24; H04B 7/26

(52) U.S. Cl. 455/11.1; 370/389; 455/39; 455/7

(57) ABSTRACT

The objective of the present invention is to improve transmission characteristics by transmitting data through multiple paths in a multihop radio network including multiple paths.

In a source node 210 of (a), an encoder 212 performs communication path encoding, and a modulator 216 modulates. Unlike the prior art, however, a packetizing unit 214 designates relay paths and packetizes outputs from the encoder 212 for the respective paths, whereby signals are transmitted to multiple paths (in this case, two paths). A receiver (See (c)) of a destination node 260 demodulates the signals from the multiple paths using a demodulator 262. Thereafter, it depacketizes the packet of binary data hard-decided by a depacketizing/buffering unit 263 and then temporarily stores the depacketized pieces of data for respective paths in a buffer. A reliability data calculator 265 then diversity-combines, taking reliability data into account. A combiner/decoder 267 performs an error correction based on that combined data.

### TECHNICAL FIELD

The present invention relates to a multihop radio network.

### BACKGROUND ART

In a multihop radio network, data is transmitted from a source node to a destination node via a relay node. Utilization of this multihop radio network for future mobile communications services has been studied. In addition, use of this multihop radio network only in certain specified regions is possible. Therefore, it may be used in wireless network establishments in various locations such as in train stations, public facilities, and condominiums, for example.

A conventional multihop radio network structure is shown in FIG. 1. FIG. 1(a) shows a structure of a network; FIG. 1(b) shows a structure of a transmitter; and FIG. 1(c) shows a structure of a receiver. Nodes 110 through 160 configuring the multihop radio network have the structures of the transmitter and the receiver shown in FIGS. 1(b) and 1(c), respectively.

In a typical transmitter of the source node 110, an encoder 112 encodes binary input data for a communication path. A packetizing unit 114 constructs packets for the resulting encoded data. A modulator 116 then modulates them, transmitting to the relay nodes 140 and 150, as shown in FIG. 1(b). The relay nodes 140 and 150 regenerate and relay the transmitted data; more specifically they demodulate received signals, conduct a hard decision thereupon returning them to binary data, and then demodulate them again. In the receiver of the destination node 160, a demodulator 162 depacketizes the demodulated signals using a depacketizing device 164, and then decodes and error corrects them using a decoder 166, as shown in FIG. 1(c).

Selection of some of multiple paths from a source node to a destination node is possible with the multihop radio network. However, with conventional techniques, only one path is selected and data is transmitted only through that path (See Non-patent Document 1).

The multihop radio network is capable of transmitting packets using multiple paths (See Non-patent Document 2). However, this is regarded as a method that reduces influences of network topological changes.

Non-patent Document 1: KITAGISHI, Yumiko, UEHARA, Hideyuki, YAMAMOTO, Ryo, YOKOYAMA, Mitsuo, ITO, Hirokazu, “Packet relay control scheme based on priority regions in multihop wireless networks”, THE JOURNAL OF THE INSTITUTE OF ELECTRONICS, INFORMATION AND COMMUNICATION ENGINEERS, pp 2119-2128, VOL. J85-B No. 12, Dec. 2002

Non-patent Document 2: Aristotelis Tsirigos, Zygmunt J. Haas, “Multipath Routing in the Presence of Frequent Topological Changes,” IEEE Communications Magazine, pp 132-138, Nov. 2001

### DISCLOSURE OF THE INVENTION

### Problem to be Solved by the Invention

Since a wireless environment is influenced by various disturbances such as fading, errors often occur in transmitted data. When only a single path is used, affects of those errors are great, thereby degrading transmission characteristics.

The objective of the present invention is to achieve improvement in transmission characteristics by transmitting data through a part of or all paths in a multihop radio network including multiple paths and utilizing signals received via those paths.

### Means for Solving the Problem

In order to achieve the above-given objective of the present invention, the present invention provides a multihop radio network system through which signals are transmitted from a source node to a destination node via a relay node, which is characterized by: a source node configured to modulate and transmit signals to reach a destination node via multiple paths; and the destination node configured to receive the signals transmitted through the multiple paths by demodulating and combining them, taking reliability data into account.

An aspect of the present invention provides a receiver system for a multihop radio network system through which signals are transmitted from a source node to a destination node via a relay node; the receiver system is characterized by a demodulator; a combiner configured to depacketize demodulated signals from respective paths and then combine the resulting signals with reliability data, and a decoder configured to decode the resulting combined signal.

The combiner should combine by averaging based on the number of the paths. Furthermore, the combiner may combine by multiplying a weight for each of the paths in accordance with the reliability data.

### Effects of the Invention

According to the above-given structure, the error rate is reduced in the multihop radio network system, and data transmission efficiency for the entire system is improved.

### BRIEF DESCRIPTION OF THE DRAWINGS

FIG. 1 is a diagram showing a structure of a conventional multihop radio network;

FIG. 2 is a diagram showing a structure of a multihop radio network of embodiments;

FIG. 3 is a diagram showing an exemplary structure using convolutional coding and soft output combining by averaging;

FIG. 4 is a diagram showing simulation results (packet loss rate) according to the exemplary structure of FIG. 3;

FIG. 5 is a diagram showing simulation results (gross traffic) according to the exemplary structure of FIG. 3; and

FIG. 6 is a diagram showing an exemplary structure using convolutional coding and soft output combining based on weights for respective paths.

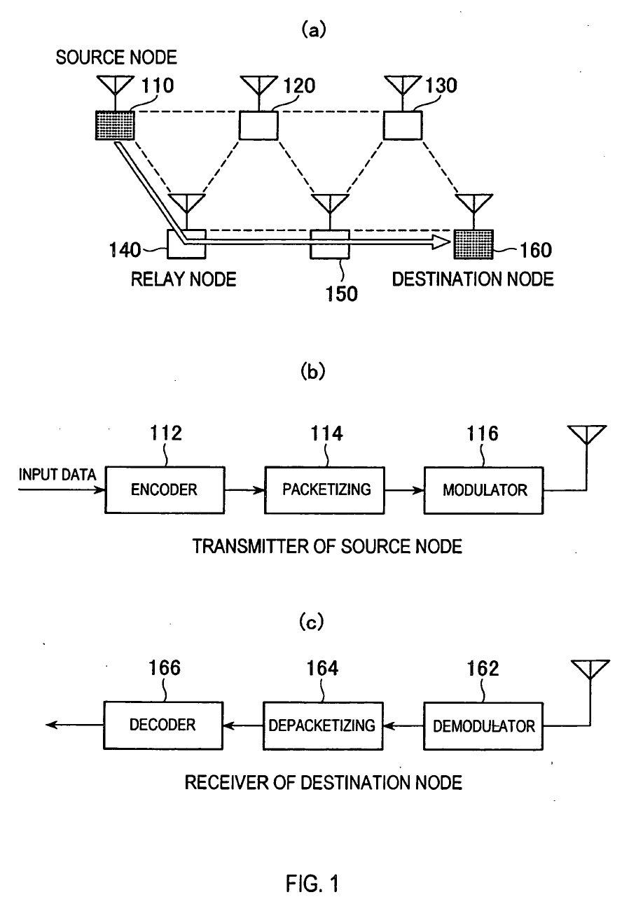

### BEST MODE FOR CARRYING OUT THE INVENTION

Structures of embodiments of the present invention are described using the appended drawings.

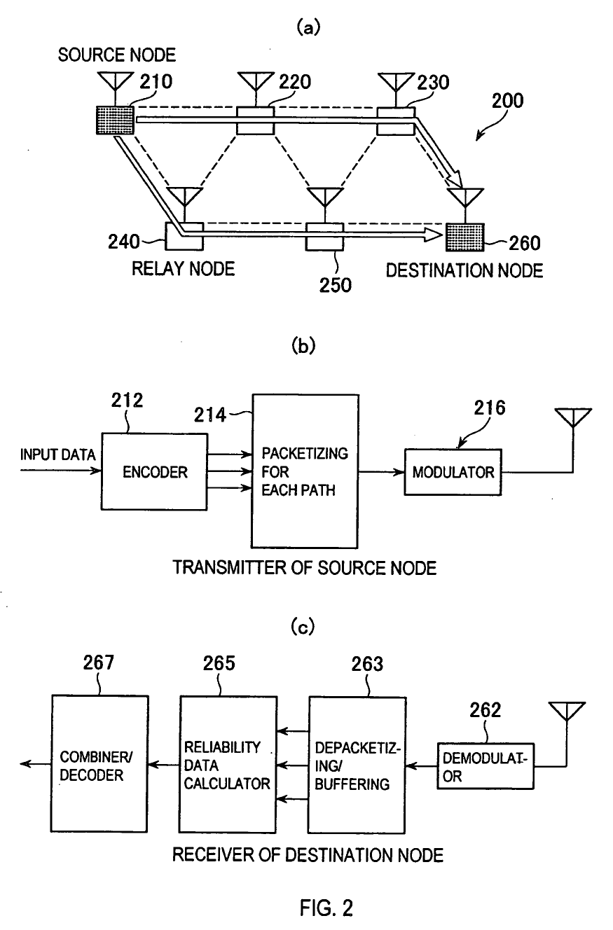

FIG. 2 is a diagram showing a general structure of embodiments of the present invention. FIG. 2(a) shows a structure of a network, FIG. 2(b) shows a structure of a transmitter, and FIG. 2(c) shows a structure of a receiver. Respective nodes 210 through 260 configuring a multihop radio network have the structures of the transmitter and the receiver shown in FIGS. 2(b) and 2(c).

As shown in FIG. 2(a), with the embodiments of the present invention, data is transmitted through a part or all of paths (in FIG. 2(a), two paths) in the multihop radio network including multiple paths, and the data received via those paths is diversity combined and decoded, improving characteristics.

In the source node 210 of FIG. 2(a), an encoder 212 performs communication path encoding, and a modulator 216 modulates, as with the prior art. Unlike the prior art, however, a packetizing unit 214 designates relay paths and packetizes outputs from the encoder 212 for the respective paths, whereby signals are transmitted to multiple paths (in this case, two paths). Note that outputs from the encoder 212 may differ for respective paths, or may be the same. For example, bit position may be varied for each of the paths.

The relay nodes 220, 230, 240, and 250 regenerate and relay as with the prior art. The receiver (See FIG. 2(c)) of the destination node 260 demodulates the signals from the multiple paths using a demodulator 262. Thereafter, it depacketizes the packet of binary data hard-decided by a depacketizing/buffering unit 263 and then temporarily stores the depacketized pieces of data for respective paths in a buffer. A reliability data calculator 265 then diversity-combines, taking reliability data into account. A combiner/decoder 267 performs an error correction based on that reliability data.

Since the signals transmitted to the destination node via the relay nodes are regenerated and relayed signals, diversity combination of the hard-decided signals (binary data) is necessary. Therefore, inputs to the reliability data calculator 265 are hard-decided values (binary data). The reliability data calculator 265 calculates likelihood for each of the bits obtained from the multiple paths as reliability information based on the hard decided values for the respective bits, and then outputs it. This output may be soft output, allowing further true representation of likelihood.

### FIRST EMBODIMENT

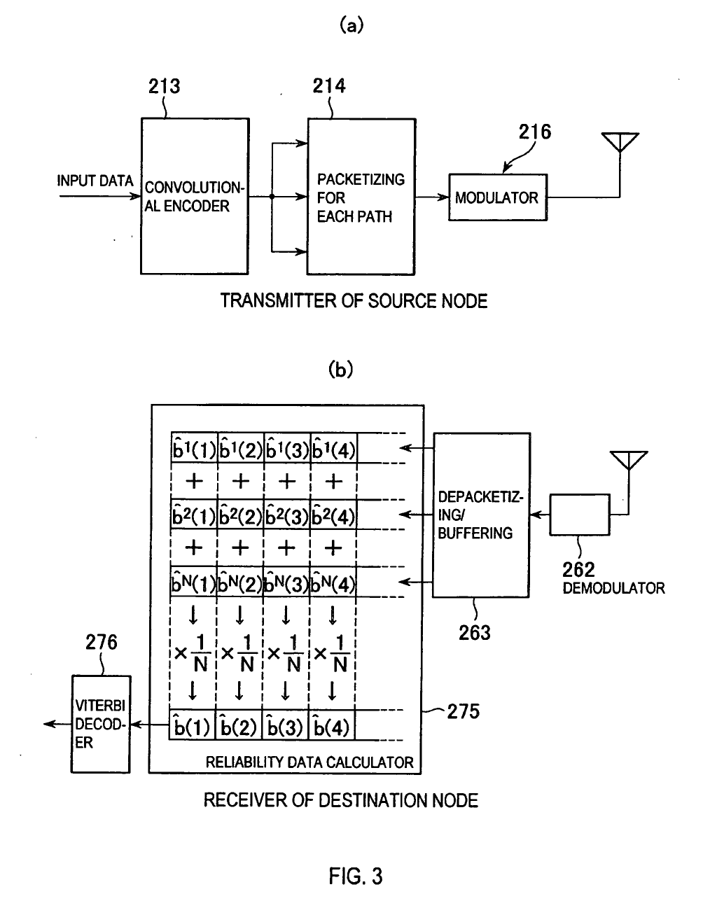

FIG. 3 shows an exemplary structure utilizing convolutional coding as communication path coding and an averaging method as a reliability-based combining method.

In a transmitter shown in FIG. 3(a), input signals are subjected to convolutional encoding by a convolutional encoder 213, the same signals from the convolutional encoder 213 are packetized by the packetizing unit 214 for respective paths, modulated by the modulator 216, and then transmitted to multiple paths (number of paths N).

In a receiver (See FIG. 3(b)), packets transmitted through each of the paths (number of paths N) are demodulated and hard-decided by the demodulator 262, and then depacketized by the depacketizing/buffering unit 263 and temporarily stored in a buffer. A reliability data calculator 275 performs diversity combination of the N number of signals hard decided for each of the paths and stored in the buffer, taking the reliability data into account. More specifically, as shown below, combination taking the reliability data into account is performed by dividing sum of the values for each of the hard-decided paths by the number of paths and then averaging the resulting values.

$$\begin{matrix}{\hat{b}}^{1} ( 1 ) + {\hat{b}}^{2} ( 1 ) + {\hat{b}}^{3} ( 1 ) + … + {\hat{b}}^{N} ( 1 ) \times \frac{1}{N} \to \hat{b} ( 1 ) & [ Numeral 1 ] \\ {\hat{b}}^{1} ( 2 ) + {\hat{b}}^{2} ( 2 ) + {\hat{b}}^{3} ( 2 ) + … + {\hat{b}}^{N} ( 2 ) \times \frac{1}{N} \to \hat{b} ( 2 ) & \end{matrix}$$

For example, in the case of transmitting a value +1 using three paths, and data demodulated on the receiver side is +1, +1, and −1, combined output based on the reliability data from the reliability data calculator 275 is +⅓. Viterbi decoding is conducted by a Viterbi decoder 276 using this combined output based on the reliability data. This may be called a soft output combination based on the reliability data.

A simulation experiment is conducted so as to determine advantages of the above-given specific structure. Simulation conditions are shown in the following table.

TABLE 1

| Error Correction Encoder | Convolutional Code |
|---|---|
| Encode Rate | ½ |
| Constraint Length | 7 |
| Modulation Method | BPSK |
| Communication Path Model | Flat Raleigh Fading |
| Number of Hops | 2 (once through relay node) |
| Data Length | 500 bits |

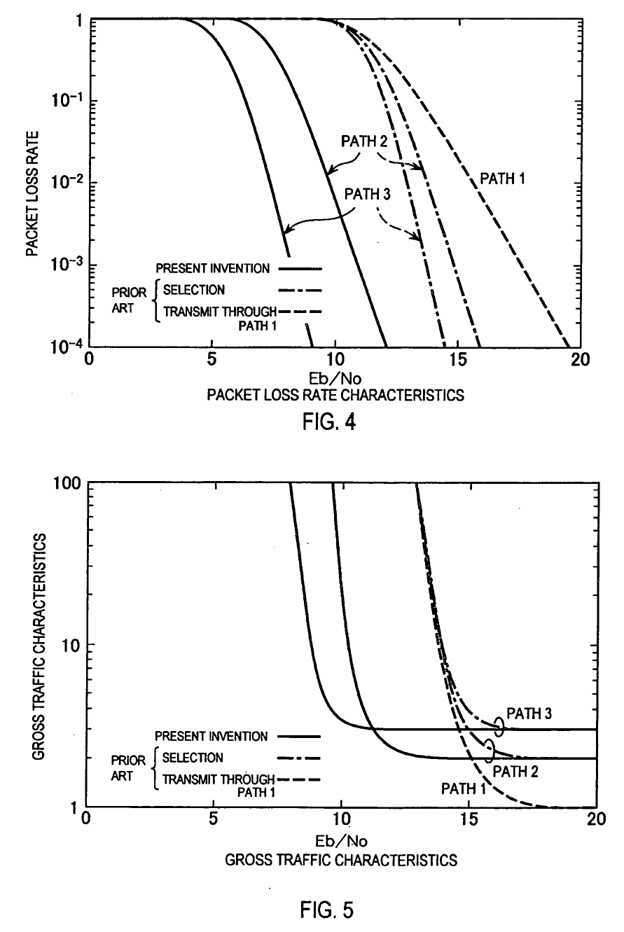

FIG. 4 shows packet loss rate characteristics. FIG. 4 shows characteristics of the present invention in cases of using two and three paths, characteristics in a case of using only one path as a conventional method, and characteristics in a case of simply selecting a path from multiple paths through which data is accurately transmitted without performing diversity combination or reliability information calculation. Since diversity combination is performed for multiple paths, characteristic improvement due to using multiple paths can be confirmed. This allows much more improvement than when simply selecting a path through which data is accurately transmitted, and benefits due to the diversity combination can be seen.

Next, gross traffic characteristics are examined to study increase in traffic due to transmission of data through multiple paths. FIG. 5 shows gross traffic characteristics normalized by the number of hops. Gross traffic characteristics result from normalizing the total number of packets transmitted over a network based on the number of hops when transmission of the packets is repeated using automatic repeat requests (ARQ) until no error is detected. For example, the case of accurately carrying out transmission in one time using two paths is counted as two.

According to a graph in FIG. 5, in the case of large signal power, characteristics with the conventional method are better because packets can be successfully transmitted without using multiple paths. However, in the case of small signal power, characteristics with the method using multiple paths are better than with the conventional method. In other words, transmission through multiple paths allows reduction in traffic and decrease in signal power.

As such, since characteristics with multiple paths in terms of the amount of traffic as well as the packet loss rate are better, higher effectiveness of the method of transmitting through multiple paths is confirmed.

### SECOND EMBODIMENT

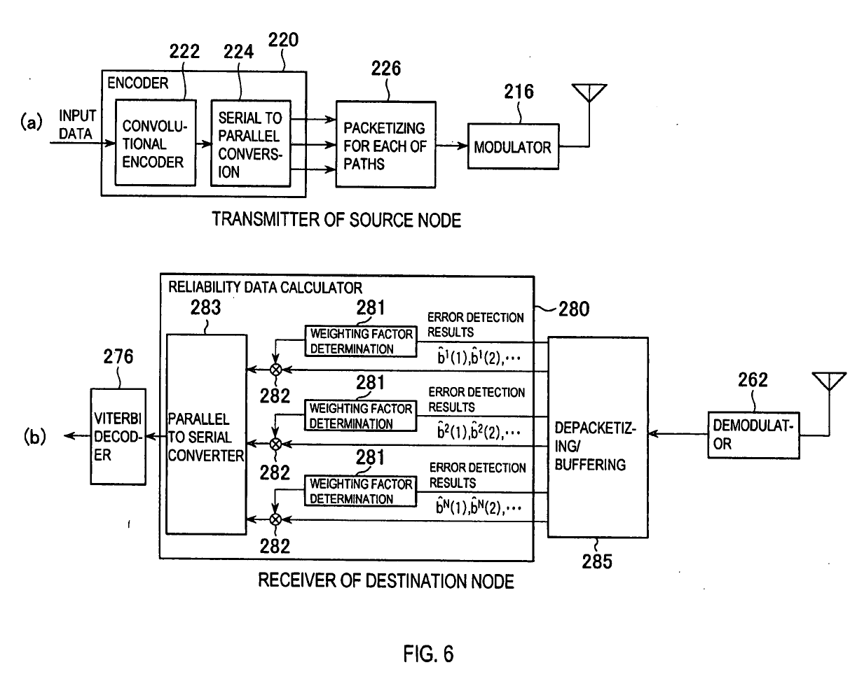

FIG. 6 shows an exemplary structure of convolutional coding as channel coding so as to generate bit streams differing from one other for each of paths, applying a weight based on reliability data for each path, and combining the resulting data.

In a transmitter shown in FIG. 6(a), input signals are convolutional encoded by a convolutional encoder 222, and serial-to-parallel converted by a serial/parallel converter 224, resulting in generation of bit streams for respective transmission paths. The output of an encoder 220 is packetized by a packetizing unit 226 for each of the paths. At this time, CRC coding or parity coding for error detection for each packet is performed.

In a receiver shown in FIG. 6(b), packets transmitted through each path are demodulated and hard-decided by a demodulator 262, depacketized by a depacketizing/buffering unit 285 and then temporarily stored in a buffer. When depacketizing, error detection of the packets is also performed for each path. In a reliability data calculator 280, a weighting factor determination unit 281 determines a weighting factor for each path in accordance with the error detection results. For example, when an error is detected, a weighting factor is set to 0.5, and when an error is not detected, a weighting factor is set to 1. These weighting factors are multiplied for each path by a multiplier 282, and serial-to-parallel converted by a serial/parallel converter 283. A reliability data calculator 280 then outputs the resulting data. Viterbi decoding is conducted by a Viterbi decoder 276 using this combined output from the reliability data calculator 280. In this manner, soft output combination may be performed in accordance with reliability data.

### OTHER EMBODIMENTS

Soft combination using reliability data is performed by averaging with the structure of FIG. 3; however, a combined output may be provided using the majority from an odd number of pieces of hard output, taking the reliability data into account. This allows lower error rate for a certain bit than that for bits transmitted through a single path. This majority method may be applied to a case of transmitting through an odd number of paths.

Convolutional coding is used as communication path coding with the structures of FIGS. 3 and 6. Alternatively, turbo coding may be used.

1. A multihop radio network system, through which a signal is transmitted from a source node to a destination node via a relay nodes, said multihop radio network system comprising:
a source node configured to modulate and transmit a signal to reach a destination node via a plurality of paths;
said relay nodes configured to regenerate and relay; and
a destination node configured to receive signals transmitted through the plurality of paths by demodulating signals by hard-decided values in each path and then combining them based on reliability data of each path.

2. A receiver system of a multihop radio network system, through which a signal is transmitted from a source node to a destination node via plurality of paths through relay nodes configured to regenerate, said receiver system comprising:
a demodulator configured to demodulate signals by hard-decided values in each path;
a combiner configured to depacketize demodulated signals for respective paths and combine them; and
a decoder configured to decode a combined signal.

3. The receiver system according to claim 2, wherein the combiner is configured to combine by averaging based on the number of paths.

4. The receiver system according to claim 2, wherein the combiner is configured to combine by multiplying by a weight based on reliability data for each of the paths.
